(19) United States
(12) Patent Application Publication
(10) Pub. No.: US 2011/0223872 A1
(43) Pub. Date: Sep. 15, 2011

(54) WIRELESS TRANSCEIVING APPARATUS

(75) Inventors: Sau-Hsuan WU, Zhonghe City (TW); Lin-Kai Chiu, Hsinchu City (TW); Ko-Yen Lin, Taichung City (TW)

(73) Assignee: NATIONAL CHIAO TUNG UNIVERSITY, Hsinchu (TW)

(21) Appl. No.: 12/961,598

(22) Filed: Dec. 7, 2010

(30) Foreign Application Priority Data
Mar. 10, 2010 (TW) 099106913

(51) Int. Cl. H04B 1/40

(52) U.S. Cl. 455/84

(57) ABSTRACT

A wireless transceiving apparatus is adapted for transceiving data between communication terminals and signal processing devices and includes transceiving devices. Each transceiving device includes: a number (M) of antenna units each including a number (T) of antenna elements; a number (M) of first processing unit for performing radio frequency (RF) beamforming; a number (M) of frequency converters; and a second processing unit for performing baseband beamforming. The wireless transceiving apparatus receives signals from the communication terminals and transmits processed signals to the communication terminals with an improved signal to interference plus noise ratio (SINR), thereby ensuring the quality of service for each communication terminal.

### CROSS-REFERENCE TO RELATED APPLICATION

This application claims priority of Taiwanese Application No. 099106913, filed on Mar. 10, 2010.

### BACKGROUND OF THE INVENTION

1. Field of the Invention

The invention relates to a wireless transceiving apparatus, and more particularly to a wireless transceiving apparatus using beamforming techniques.

2. Description of the Related Art

For wireless communication techniques using a carrier wave of 60 GHz, a data transmission rate of 1 G bit/sec can be attained such that high-definition multimedia data can be downloaded by an indoor user terminal within a very short period.

Generally, the size of antennas built in a transceiving device depends on the wavelength of a carrier wave. For example, when a carrier wave of 60 GHz is used, tens of tiny antennas are required, and preferably, the beam directivity for each antenna can be decided through the beamforming manner.

A conventional transceiving device includes an 8×8 array of planar antennas that are divided into four blocks of the planar antennas. The conventional transceiving device corrects phases of signals received by the planar antennas in each block in accordance with a specific corrected phase that is decided based on the orientation of each block of the planar antennas relative to a user terminal. The conventional transceiving device synthesizes the signals in accordance with four beamforming weights to maintain the quality of service for the user terminal.

However, since orientations of the planar antennas in each block relative to the user terminal are different from each other, beamforming cannot be accurately performed. Furthermore, the conventional transceiving device cannot effectively receive and transmit data from and to two user terminals at the same time.

### SUMMARY OF THE INVENTION

Therefore, an objective of the present invention is to provide a wireless transceiving apparatus that can overcome the aforesaid disadvantages of the prior art.

According to the present invention, there is provided a wireless transceiving apparatus for transceiving data between at least one communication terminal and at least one signal processing device. The wireless transceiving apparatus comprises:

at least one transceiving device operable between a receiving mode, where a signal from the communication terminal is transmitted to the signal processing device, and a transmission mode, where a processed signal from the signal processing device is transmitted to the communication terminal, the transceiving device including
a number (M) of antenna units each having a number (T) of antenna elements, where M≧2 and T≧2,
a number (M) of first processing units coupled respectively to the antenna units,
a number (M) of frequency converters coupled respectively to the first processing units, and
a second processing unit coupled to the frequency converters and adapted to be connected electrically to the signal processing device.

When the transceiving device is in the receiving mode,
each of the antenna elements of each of the antenna units generates an antenna signal upon receipt of the signal from the communication terminal,
each of the first processing units receives the antenna signals from the antenna elements of a corresponding one of the antenna units, is operable to generate a radio frequency (RF) signal based on the antenna signals received thereby, and outputs the RF signal to a corresponding one of the frequency converters,
each of the frequency converters receives and converts the RF signal from the corresponding one of the first processing units into a baseband signal, and outputs the baseband signal to the second processing unit, and
the second processing unit receives the baseband signals from the frequency converters, is operable to generate an output signal corresponding to the signal transmitted by the communication terminal based on the baseband signals received thereby, and outputs the output signal to the signal processing device.

When the transceiving device is in the transmission mode,
the second processing unit receives the processed signal from the signal processing device, is operable to generate a number (M) of baseband signals based on the processed signal received thereby, and outputs respectively the baseband signals to the frequency converters,
each of the frequency converters receives and converts a corresponding one of the baseband signals from the second processing unit into an RF signal, and outputs the RF signal to the corresponding one of the first processing units, and
each of the first processing units receives the RF signal from the corresponding one of the frequency converters, is operable to generate a number (T) of antenna signals based on the RF signal received thereby, and transmits the antenna signals to the communication terminal through the antenna elements of the corresponding one of the antenna units, respectively.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating the preferred embodiment of a wireless transceiving apparatus according to the present invention;

FIG. 2 is a schematic circuit block diagram illustrating a first processing unit of a transceiving device of the preferred embodiment;

FIG. 3 is a schematic circuit block diagram illustrating a second processing unit of the transceiving device and a weight generator of the preferred embodiment when the transceiving device is in a receiving mode;

FIG. 4 is a schematic circuit block diagram illustrating the second processing unit of the transceiving device and the weight generator of the preferred embodiment when the transceiving device is in a transmission mode;

FIG. 5 is a schematic view showing a first antenna array formed by all antenna elements of the preferred embodiment;

FIG. 6 is a polar plot of a hybrid beam pattern at the plan of φ=0° of the first antenna array;

FIG. 7 is a schematic view showing a second antenna array formed by the antenna elements of the preferred embodiment;

FIG. 8 is a polar plot of a hybrid beam pattern at the plan of φ=0° of the second antenna array;

FIG. 9 is a schematic view showing a third antenna array formed by the antenna elements of the preferred embodiment; and

FIG. 10 is a polar plot of a hybrid beam pattern at the plan of φ=0° of the third antenna array.

### DETAILED DESCRIPTION OF THE PREFERRED EMBODIMENT

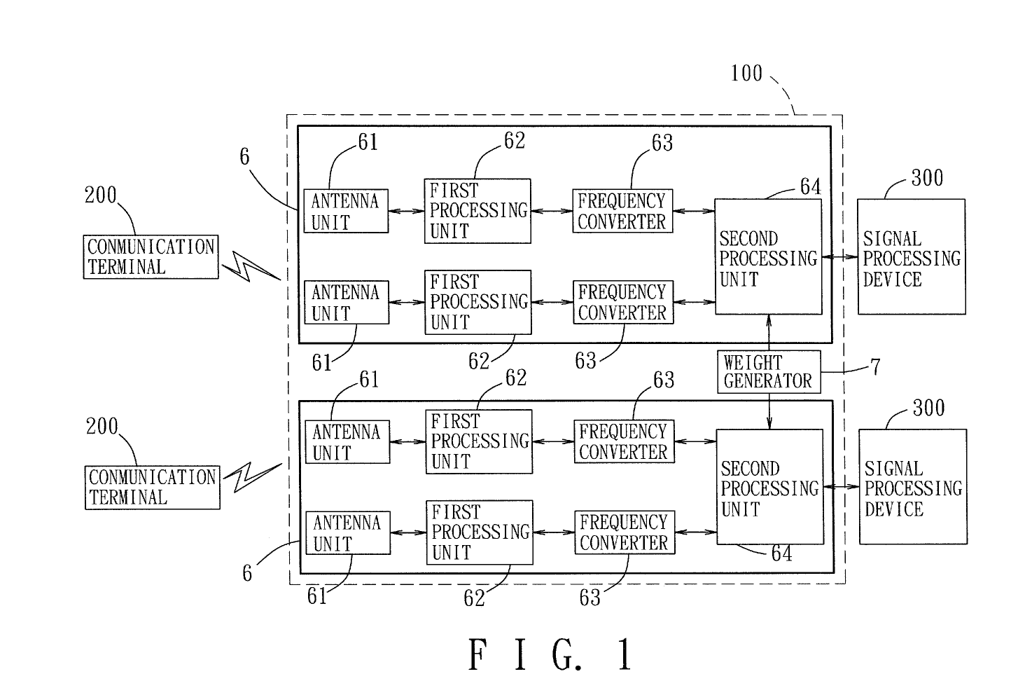

Referring to FIG. 1, the preferred embodiment of a wireless transceiving apparatus 100 according to the present invention is shown to be adapted for transceiving data between two communication terminals 200 and two signal processing devices 300 in a wireless personal area network (WPAN) over a carrier wave of 60 GHz using spatial division multiple access (SDMA) techniques. The wireless transceiving apparatus 100 includes two transceiving devices 6, and a weight generator 7.

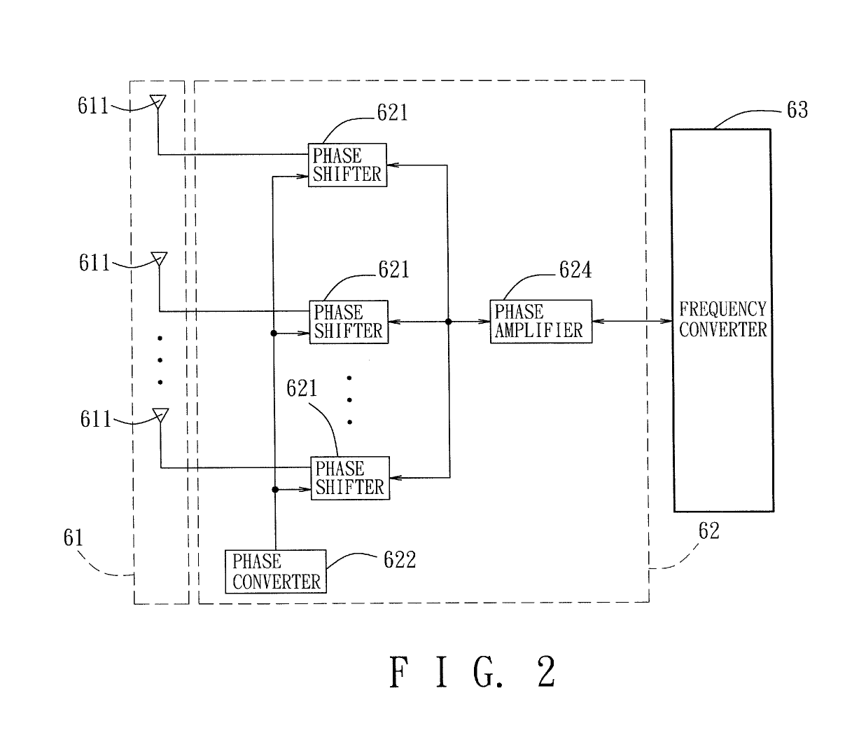

Each transceiving device 6 is capable of transceiving data between a corresponding communication terminal 200 and a corresponding signal processing device 300 through two-stage beamforming. Each transceiving device 6 is operable between a receiving mode, where a signal from the corresponding communication terminal 200 is transmitted to the corresponding signal processing device 300, and a transmission mode, where a processed signal from the corresponding signal processing device 300 is transmitted to the corresponding communication terminal 200. Each transceiving device 6 include a number (M) of antenna units 61 each including a number (T) of antenna elements 611 (see FIG. 2), a number (M) of first processing units 62 coupled respectively to the antenna units 61, a number (M) of frequency converters 63 coupled respectively to the first processing units 62, and a second processing unit 64 coupled to the frequency converters 63 and adapted to be connected electrically to the corresponding signal processing device 300, where M=2 and T=16 in this embodiment.

When each transceiving device 6 is in the receiving mode, each antenna element 611 of each antenna unit 61 generates an antenna signal upon receipt of the signal from the corresponding communication terminal 200. Each first processing unit 62 receives the antenna signals from the antenna elements 611 of a corresponding antenna unit 61, is operable to generate a radio frequency (RF) signal based on the antenna signals received thereby, i.e., performs first-stage beamforming, and outputs the RF signal generated thereby to a corresponding frequency converter 63. Each frequency converter 63 receives and converts the RF signal from the corresponding first processing unit 62 into a baseband signal using a carrier wave of 60 GHz, and outputs the baseband signal to the second processing unit 64. The second processing unit 64 receives the baseband signals from the frequency converters 63, is operable to generate an output signal corresponding to the signal transmitted by the corresponding communication terminal 200 based on the baseband signals received thereby, i.e., performs second-stage beamforming, and outputs the output signal to the corresponding signal processing device 300 for further analysis.

When each transceiving device 6 is in the transmission mode, the second processing unit 64 receives the processed signal from the corresponding signal processing device 300, is operable to generate a number (M) of baseband signals based on the processed signal received thereby, and outputs respectively the baseband signal to the frequency converters 63. Each frequency converter 63 receives and converts a corresponding baseband signal from the second processing unit 64 into an RF signal, and outputs the RF signal to the corresponding first processing unit 62.

For each transceiving device 6, referring to FIG. 2, each first processing unit 62 includes a number (T) of phase shifters 621 coupled respectively to the antenna elements 611 of the corresponding antenna unit 61, a phase controller 622 coupled to the phase shifters 621, and a power amplifier 624 coupled to the phase shifters 621 and the corresponding frequency converter 63. For each first processing unit 62, each phase shifter 621 receives the antenna signal from the corresponding antenna element 611 of the corresponding antenna unit 61 or the RF signal from the corresponding frequency converter 63. The phase controller 622 is operable to generate a number (T) of phase correction signals based on orientations of the respective antenna elements 611 of the corresponding antenna unit 61 relative to the corresponding communication terminal 200, and outputs respectively the phase correction signals to the phase shifters 621. As such, when a corresponding transceiving device 6 is in the receiving mode, each phase shifter 621 adjusts the phase of the antenna signal received thereby to generate an output based on a corresponding phase correction signal from the phase controller 622 such that a sum of the outputs generated by the phase shifters 621 constitutes the RF signal generated by a corresponding first processing unit 62 and can be obtained by an adder (not shown). When the corresponding transceiving device 6 is in the transmission mode, each phase shifter 621 adjusts the phase of the RF signal received thereby to generate a corresponding antenna signal based on the corresponding phase correction signal from the phase controller 622. When the corresponding transceiving device 6 is in the receiving mode, the power amplifier 624 amplifies the sum of the outputs from the phase shifters 621 to output the RF signal to the corresponding frequency converter 63. In this case, the power amplifier 624 serves as a low-noise amplifier. When the corresponding transceiving device 6 is in the transmission mode, the power amplifier 624 amplifies the RF signal from the corresponding frequency converter 63 and provides the RF signal amplified thereby to each phase shifter 621.

It is noted that, in each transceiving device 6, each antenna unit 61 corresponds to a single power amplifier 624 and a single frequency converter 63 for power amplifying and frequency conversion purposes.

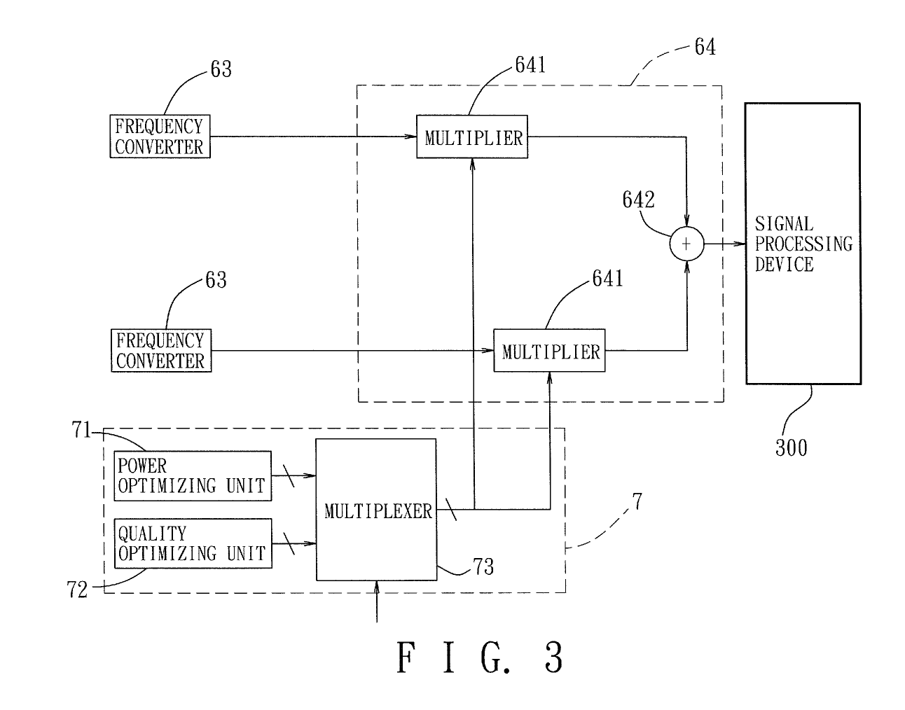

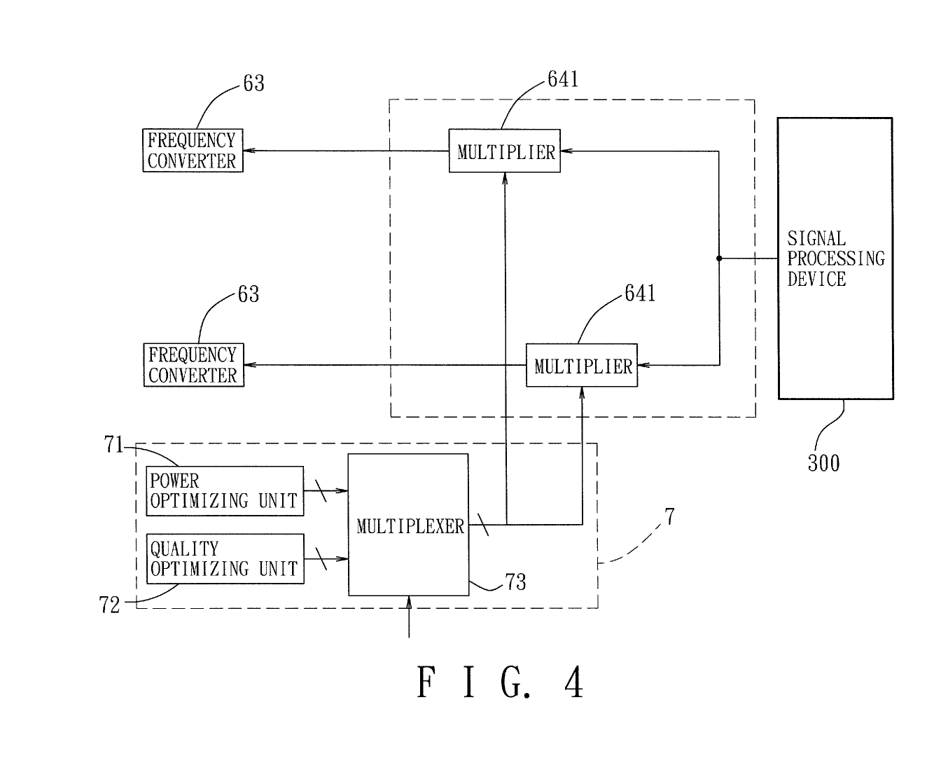

For each transceiving device 6, referring to FIGS. 3 and 4, the second processing unit 64 includes a number (M) of multipliers 641 each coupled to a corresponding frequency converter 63 for receiving the baseband signal therefrom when a corresponding transceiving device 6 is in the receiving mode. When the corresponding transceiving device 6 is in the receiving mode, as shown in FIG. 3, each multiplier 641 multiplies the baseband signal received thereby by a specific receiving beamforming weight, which is in the form of a complex number, to generate an output. As such, a sum of the outputs generated by the multipliers 641 is obtained by an adder 642 and serves as the output signal output by the second processing unit 64. When the corresponding transceiving device 6 is in the transmission mode, as shown in FIG. 4, each multiplier 641 multiplies the processed signal from the corresponding signal processing device 300 by a specific transmission beamforming weight, which is in the form of a complex number, to generate a corresponding baseband signal, and outputs the corresponding baseband signal to the corresponding frequency converter 63.

The weight generator 7 is coupled to the second processing units 64 of the transceiving devices 6, is operable to generate a number (M) of control signals indicative of the receiving beamforming weights or the transmission beamforming weights for each transceiving device 6 based on a predetermined quality threshold and a predetermined power threshold, and outputs respectively the controls signals to the multipliers 641 of the second processing unit 64 such that each multiplier 641 of the second processing unit of each transceiving device 6 performs multiplication in response to a corresponding one of the control signals from said weight generator 7.

In this embodiment, the weight generator 7 includes a power optimizing unit 71, a quality optimizing unit 72 and a multiplexer 73. The power optimizing unit 71 is operable to generate a number (M) of first control signals for each transceiving device 6 under a condition, where the signal to interference plus noise ratio (SINR) of each antenna signal transmitted to the corresponding communication terminal 200 is greater than the predetermined quality threshold, using, for example, the CVX program proposed in an article by M. Grant and S. Boyd, entitled “CVX: Matlab software for disciplined convex programming (web page and software),” February 2009. The quality optimizing unit 72 is operable to generate a number (M) of second control signals for each transceiving device 6 under a condition, where power of the processed signal from the corresponding signal processing device 300 or the output signal generated by the second processing unit 64 is less than the predetermined power threshold, using, for example, an algorithm disclosed in an article by Wiesel, Y. C. Eldar and S. Shamai, entitled “Linear precoding via conic optimization for fixed MIMO receivers”, IEEE Trans. on Signal Processing, vol. 54, no. 1, pp. 161-176, January 2006. The multiplexer 73 is coupled to the power optimizing unit 71 and the quality optimizing unit 72 for receiving the first and second control signals therefrom, and to the multipliers 641 of the second processing unit 64 of each transceiving device 6 for outputting respectively the control signals to the multipliers 641 of the second processing unit 64 of each transceiving device 6. The multiplexer 73 is operable to select the first control signals or the second control signals received thereby as the control signals output respectively to the multipliers 641 of the second processing unit 64 of a corresponding transceiving device 6 in response to an external input signal.

For each transceiving device 6, when the first control signals generated by the power optimizing unit 71 serve as the control signals output respectively by the multiplexer 73 to the multipliers 641 of the second processing unit 64, the second processing unit 64 is operable based the first control signals to minimize power of the output signal generated thereby. When the second control signals generated by the quality optimizing unit 72 serve as the control signal output respectively by the multiplexer 73 to the multipliers 641 of the second processing unit 64, the second processing unit 64 is operable based on the second control signals to maximize the SINR of the output signal generated thereby or each antenna signal transmitted to the corresponding communication terminal 200.

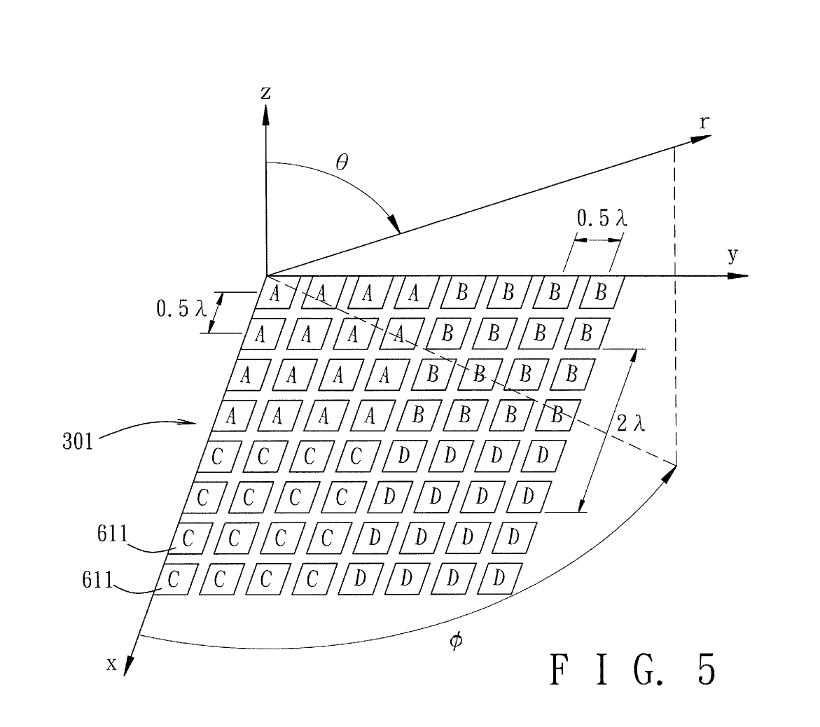

The wireless transceiving apparatus 100 has 64 (2×2×16) antenna elements 611 that are in the form of identical patch antennas each having a size smaller than 0.5λ×0.5λ, where λ is the wavelength of the carrier wave. In this embodiment, all antenna elements 611 are arranged to form an 8×8 first antenna array 301, as shown in FIG. 5, wherein a distance between centers of any adjacent two of the antenna elements 611 is equal to 0.5λ. The antenna elements 611 of each antenna unit 61 of each transceiving device 6 indicated by the same symbol (A, B, C, D) are arranged to form a 4×4 antenna array, wherein a distance between centers of any adjacent two of the antenna elements 611 is equal to 0.5λ. Thus, two 4×4 antenna arrays indicated by the symbols (A, D) correspond to one transceiving device 6, and the other two 4×4 antenna arrays indicated by the symbols (B, C) correspond to the other transceiving device 6. As a result, the four 4×4 antenna arrays constitute the first antenna array 301. A distance between centers of any adjacent two of the 4×4 antenna arrays is equal to 2λ.

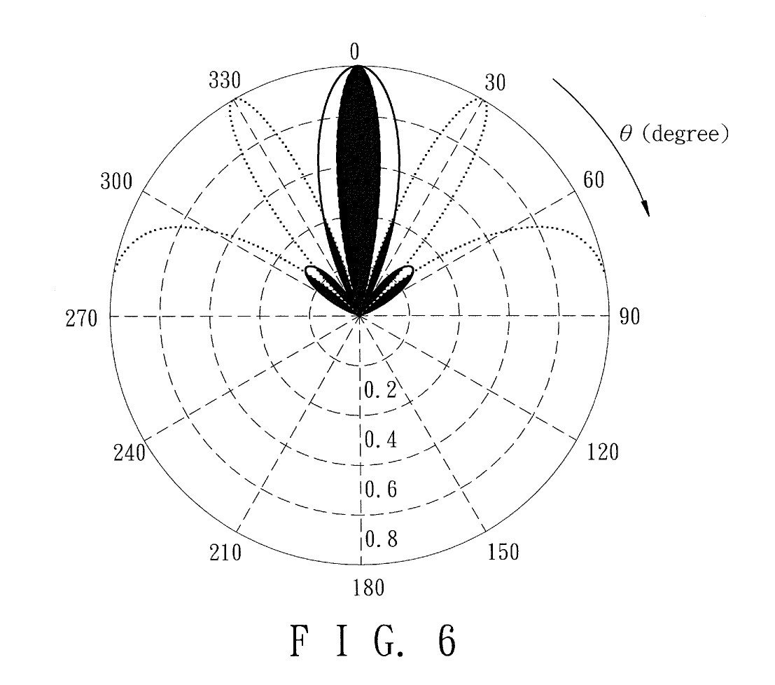

For example, as shown in FIG. 5, all antenna elements 611 are placed in an x-y plane, and a target communication terminal 200 to be communicated with is located in a spatial direction indicated by a vector (\vec{r}), where θ represents an angle between the vector (\vec{r}) and a Z-axis, and φ represents an angle between a component of the vector (\vec{r}) in the x-y plane and an x-axis. In this case, when φ=0°, an RF beam pattern of the antenna elements 611 corresponding to the first-stage beamforming is indicated by solid lines in FIG. 6. A baseband beam pattern of the antenna elements 611 corresponding to the second-stage beamforming is indicated by dotted lines in FIG. 6, and has periodically spaced apart side-lobes. Thus, a hybrid beam pattern of the first antenna array 301 can be obtained by multiplying the RF beam pattern by the baseband beam pattern, and is indicated by shaded areas in FIG. 6. The hybrid beam pattern has a main lobe with a relatively large amplitude at θ=0° and several side-lobes with small amplitudes. Therefore, the wireless transceiving apparatus 100 of the present invention can reduce interference to the other communication terminal 200, thereby improving the SINR.

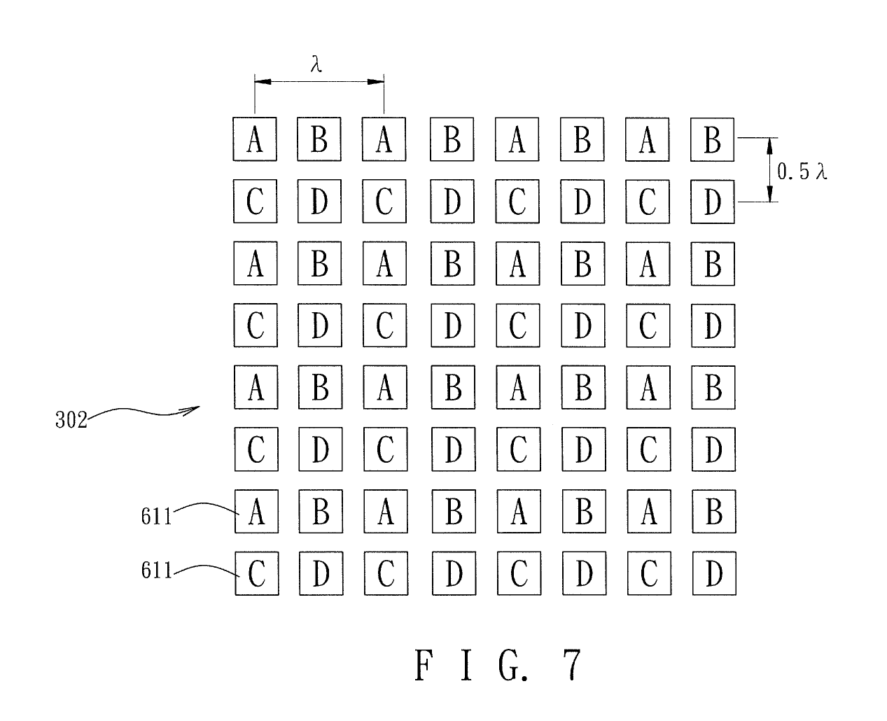

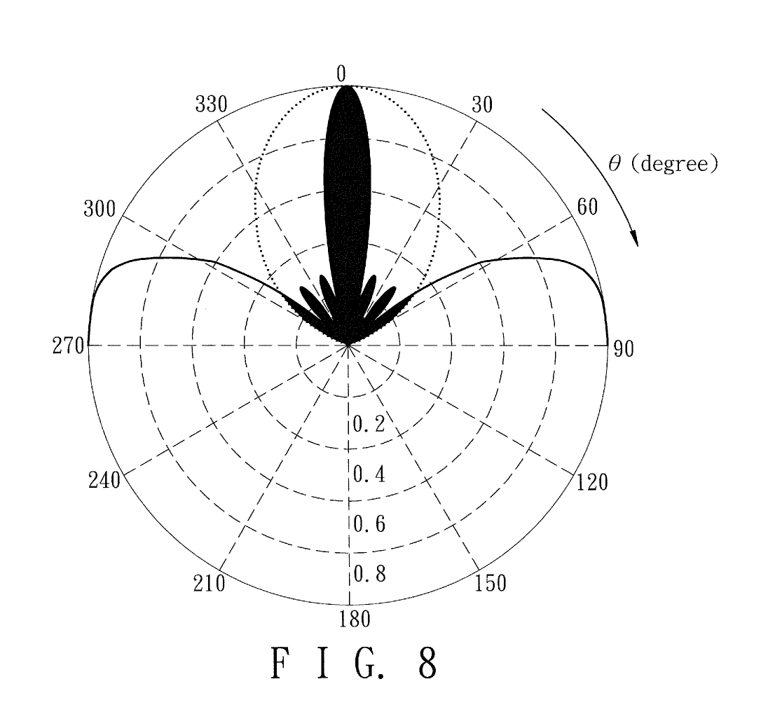

In other embodiments, all antenna elements 611 are arranged to form an 8×8 second antenna array 302, as shown in FIG. 7, wherein a distance between centers of any adjacent two of the antenna elements 611 is equal to 0.5λ. The antenna elements 611 of each antenna unit 61 of each transceiving device 6 indicated by the same symbol (A, B, C, D) are arranged to form a 4×4 antenna array, wherein a distance between centers of any adjacent two of the antenna elements 611 indicated by the same symbol is equal to λ. Thus, two 4×4 antenna arrays indicated by the symbols (A, D) correspond to one transceiving device 6, and the other two 4×4 antenna arrays indicated by the symbols (B, C) correspond to the other transceiving device 6. As a result, the four 4×4 antenna arrays constitute the second antenna array 302. According to the above example, a baseband beam pattern indicated by dotted lines in FIG. 8 has no side-lobe such that high beam directivity to the target communication terminal 200 can be obtained. A hybrid beam pattern of the second antenna array 302 is indicated by block areas in FIG. 8. Therefore, the wireless transceiving apparatus 100 can effectively reduce interference to the other communication terminal 200 to provide superior SINR, thereby facilitating communication with two communication terminals 200 at the same time. However, such second antenna array 302 may be configured through a complicated wiring.

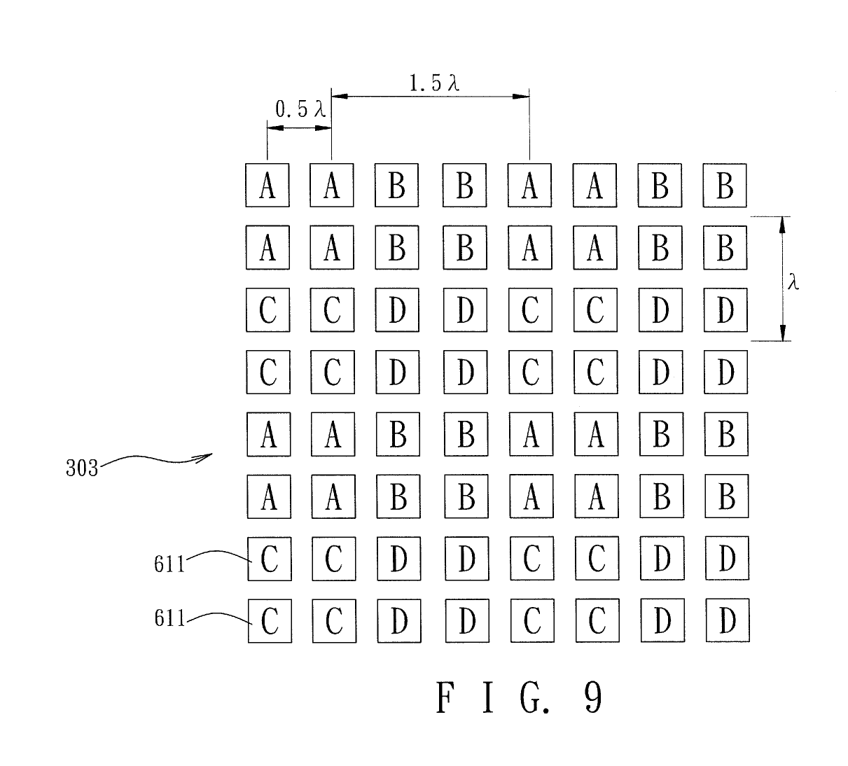

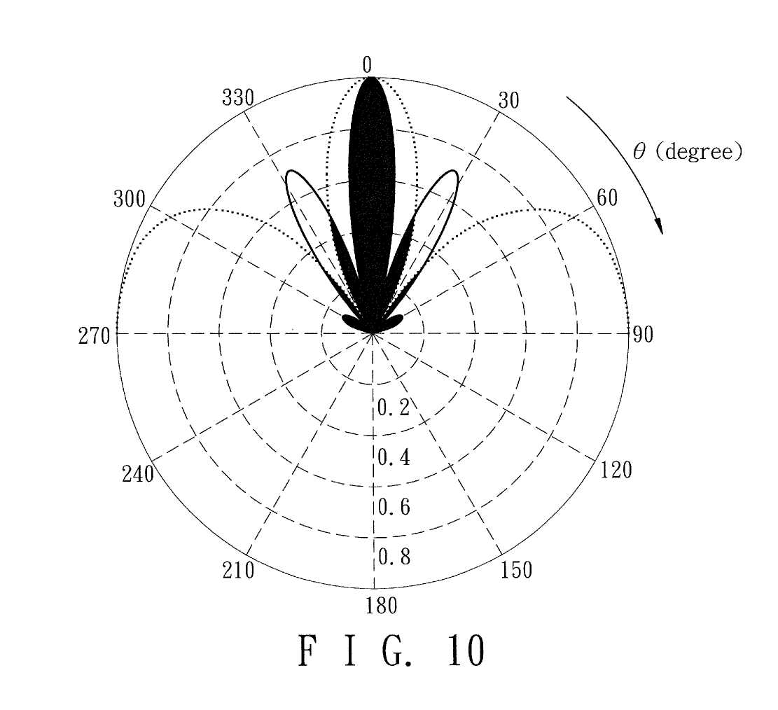

Alternatively, all antenna elements 611 are arranged to form an 8×8 third antenna array 303, as shown in FIG. 9, wherein a distance between centers of any adjacent two of the antenna elements 611 is equal to 0.5λ. The antenna elements 611 of each antenna unit 61 of each transceiving device 6 indicated by the same symbol (A, B, C, D) are arranged to form four 2×2 antenna arrays, and are disposed so that a distance between centers of any adjacent two of the antenna elements 611 indicated by the same symbol is equal to one of 0.5λ and 1.5λ. Thus, two 4×4 antenna arrays indicated by the symbols (A, D) correspond to one transceiving device 6, and the other two 4×4 antenna arrays indicated by the symbols (B, C) correspond to the other transceiving device 6. As a result, the sixteen 2×2 antenna arrays constitute the third antenna array 303. According to the above example, a baseband beam pattern indicated by dotted lines in FIG. 10 has fewer side-lobes compared to the baseband beam pattern of the first antenna array 301, thereby improving the SINR. A hybrid beam pattern of the third antenna array 303 is indicated by block areas in FIG. 10. Therefore, the wireless transceiving apparatus 100 can maintain superior SINR and ensure communication with two communication terminals 200 at the same time. In addition, the third antenna array 303 can be configured through relatively simple wiring compared to the second antenna array 302.

In sum, the wireless transceiving apparatus 100 of the present invention can ensure communication with two communication terminals 200 at the same time, and can also support selectively a desired communication terminal 200 with high data transceiving accuracy.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A wireless transceiving apparatus for transceiving data between at least one communication terminal and at least one signal processing device, said wireless transceiving apparatus comprising:
at least one transceiving device operable between a receiving mode, where a signal from the communication terminal is transmitted to the signal processing device, and a transmission mode, where a processed signal from the signal processing device is transmitted to the communication terminal, and including
a number (M) of antenna units each having a number (T) of antenna elements, where M≧2 and T≧2,
a number (M) of first processing units coupled respectively to said antenna units,
a number (M) of frequency converters coupled respectively to said first processing units, and
a second processing unit coupled to said frequency converters and adapted to be connected electrically to the signal processing device;
wherein, when said transceiving device is in the receiving mode,
each of said antenna elements of each of said antenna units generates an antenna signal upon receipt of the signal from the communication terminal,
each of said first processing units receives the antenna signals from said antenna elements of a corresponding one of said antenna units, is operable to generate a radio frequency (RF) signal based on the antenna signals received thereby, and outputs the RF signal to a corresponding one of said frequency converters,
each of said frequency converters receives and converts the RF signal from the corresponding one of said first processing units into a baseband signal, and outputs the baseband signal to said second processing unit, and
said second processing unit receives the baseband signals from said frequency converters, is operable to generate an output signal corresponding to the signal transmitted by the communication terminal based on the baseband signals received thereby, and outputs the output signal to the signal processing device; and
wherein, when said transceiving device is in the transmission mode,
said second processing unit receives the processed signal from the signal processing device, is operable to generate a number (M) of baseband signals based on the processed signal received thereby, and outputs respectively the baseband signals to said frequency converters,
each of said frequency converters receives and converts a corresponding one of the baseband signals from said second processing unit into an RF signal, and outputs the RF signal to the corresponding one of said first processing units, and
each of said first processing units receives the RF signal from the corresponding one of said frequency converters, is operable to generate a number (T) of antenna signals based on the RF signal received thereby, and transmits the antenna signals to the communication terminal through said antenna elements of the corresponding one of said antenna units, respectively.

2. The wireless transceiving apparatus as claimed in claim 1, wherein each of said first processing units includes
a number (T) of phase shifters each coupled between a corresponding one of said antenna elements of the corresponding one of said antenna units and the corresponding one of said frequency converters, each of said phase shifters receiving the antenna signal from the corresponding one of said antenna elements of the corresponding one of said antenna units, or the RF signal from the corresponding one of said frequency converters; and
a phase controller coupled to said phase shifters, operable to generate a number (T) of phase correction signals based on orientations of said respective antenna elements of the corresponding one of said antenna units relative to the communication terminal, and outputting respectively the phase correction signals to said phase shifters such that each of said phase shifters adjusts the phase of the antenna signal received thereby to generate an output based on a corresponding one of the phase correction signals from said phase controller when said transceiving device is in the receiving mode, and that each of said phase shifters adjusts the phase of the RF signal received thereby to generate a corresponding one of the antenna signals based on the corresponding one of the phase correction signals from said phase controller when said transceiving device is in the transmission mode; and
wherein, when said transceiving device is in the receiving mode, a sum of the outputs generated by said phase shifters of each of said first processing units constitutes the RF signal generated by a corresponding one of said first processing units.

3. The wireless transceiving apparatus as claimed in claim 2, wherein each of said first processing units further includes a power amplifier coupled to said phase shifters and the corresponding one of said frequency converters for amplifying the sum of the outputs from said phase shifters of the corresponding one of said first processing units to generate the RF signal when said transceiving device is in the receiving mode, and for amplifying the RF signal from the corresponding one of said frequency converters when said transceiving device is in the transmission mode.

4. The wireless transceiving apparatus as claimed in claim 1, wherein:
each of said frequency converters performs conversion between the RF signal from the corresponding one of said first processing units and the corresponding one of the baseband signals from said second processing unit in accordance with a high-frequency carrier wave;
said antenna elements of said antenna units are in the form of identical patch antennas each having a size smaller than 0.5λ×0.5λ, where λ is the wavelength of the carrier wave, and are arranged so that a distance between centers of any adjacent two of said antenna elements is equal to 0.5λ.

5. The wireless transceiving apparatus as claimed in claim 4, wherein T=16, and said antenna elements of each of said antenna units of said transceiving device are arranged to form a 4×4 antenna array such that a distance between centers of any adjacent two of said antenna elements of each of said antenna units being equal to one of 0.5λ and λ.

6. The wireless transceiving apparatus as claimed in claim 4, wherein T=16, and said antenna elements of each of said antenna units of said transceiving device are arranged to form four of 2×2 antenna arrays such that a distance between centers of any adjacent two of said antenna elements of each of said antenna units being equal to one of 0.5λ and 1.5λ.

7. The wireless transceiving apparatus as claimed in claim 1, wherein:
said second processing unit includes a number (M) of multipliers each coupled to a corresponding one of said frequency converters for receiving the baseband signal therefrom when said transceiving device is in the receiving mode;
when said transceiving device is in the receiving mode, each of said multipliers multiplies the baseband signal received thereby by a specific receiving beamforming weight to generate an output, a sum of the outputs generated by said multipliers serving as the output signal output by said second processing unit; and
when said transceiving device in the transmission mode, each of said multipliers multiplies the processed signal from the signal processing device by a specific transmission beamforming weight to generate a corresponding one of the baseband signals, and outputs the corresponding one of the baseband signals to the corresponding one of the frequency converters.

8. The wireless transceiving apparatus as claimed in claim 7, further comprising a weight generator coupled to said second processing unit, operable to generate at least a number (M) of control signals indicative of the receiving beamforming weights or the transmission beamforming weights based on a predetermined quality threshold and a predetermined power threshold, and outputting respectively the controls signals to said multipliers of said second processing unit such that each of said multipliers of said second processing unit performs multiplying operation in response to a corresponding one of the control signals from said weight generator.

9. The wireless transceiving apparatus as claimed in claim 8, wherein said weight generator includes
a power optimizing unit operable to generate at least a number (M) of first control signals under a condition, where the signal to interference plus noise ratio (SINR) of each of the antenna signals transmitted to the communication terminal is greater than the predetermined quality threshold,
a quality optimizing unit operable to generate at least a number (M) of second control signals under a condition, where power of the processed signal from the signal processing device or the output signal generated by said second processing unit is less than the predetermined power threshold, and
a multiplexer coupled to said power optimizing unit and said quality optimizing unit for receiving the first and second control signals therefrom, and to said multipliers for outputting respectively the control signals to said multipliers of said second processing unit, said multiplexer being operable to select the first control signals or the second control signals received thereby as the control signals in response to an external input signal;
wherein, when the first control signals serve as the control signals output respectively to said multipliers of said second processing unit, said second processing unit is operable based the first control signals to minimize power of the output signal generated thereby; and
wherein, when the second control signals serve as the control signals output respectively to said multipliers of said second processing unit, said second processing unit is operable based on the second control signals to maximize the SINR of the output signal generated thereby or each of the antenna signals transmitted to the communication terminal.
